(19) United States
(12) Patent Application Publication
(10) Pub. No.: US 2012/0033787 A1
(43) Pub. Date: Feb. 9, 2012

(54) METHOD FOR RADIOGRAPHIC INSPECTION OF COMPONENTS

(75) Inventors: Karl SCHREIBER, Am Mellensee (DE); Josef GEITNER, Stahnsdorf (DE)

(73) Assignee: ROLLS-ROYCE DEUTSCHLAND LTD & CO KG, Blankenfelde-Mahlow (DE)

(21) Appl. No.: 13/204,244

(22) Filed: Aug. 5, 2011

(30) Foreign Application Priority Data
Aug. 9, 2010 (DE) 10 2010 033 761.7

(51) Int. Cl. G01N 23/18

(52) U.S. Cl. 378/58

(57) ABSTRACT

During the radiographic inspection of components by X-rays for better detection of defects, preferably automated, an uneven surface topography (2) of the component (1) is covered with a smoothening layer (8) made of a material whose volume-specific radiation absorption corresponds to that of the component material, so that a decrease of radiation absorption or an increase in radiation intensity due to the uneven surface topography is reduced to accentuate a radiation effect caused by internal material defects.

This application claims priority to German Patent Application DE102010033761.7 filed Aug. 9, 2010, the entirety of which is incorporated by reference herein.

This invention relates to a method for radiographic inspection of components by X-rays or gamma rays according to the basic principle that the absorption and intensity of the radiation impinging on the radiographic film upon passing the component is changed by material defects.

Radiographic inspection is an imaging method for non-destructive material testing in which a component under inspection is subjected to radiation by use of a suitable radiation source, for example an X-ray tube, and a projected image of the component recorded on radiographic film. Voids, inclusions, segregations, gas cavities, cracks or bonding defects present in the component are made visible due to different radiation absorption and correspondingly changed radiation attenuation, with higher radiation intensity resulting in an increase in density on the radiographic film.

The detectability of material defects is impaired by edge blur, i.e. a penumbra area around the imperfection, and reduced contrast (density difference) which may be caused by scatter of the electromagnetic waves impinging on an irregular component surface. However, an irregular surface structure of the component to be inspected, for example in the form of surface porosity, primarily leads to reduced radiation absorption and correspondingly high radiation intensity. The densities so produced on the radiographic film do however not represent relevant material defects, but rather falsify the inspection result or do not allow precise detection of material defects or safe automatic evaluation of the radiographic films to be made.

In a broad aspect, the present invention provides a method for radiographic inspection of components by which safe detectability of imperfections present in the component material is ensured.

Radiographic inspection of components by use of X-rays or gamma rays is accomplished according to the basic principle that the absorption and intensity of the radiation impinging on the radiographic film upon passing the component is changed by material defects in the component, with the density of the radiographic film being influenced by the intensity of the radiation. The present invention, in essence, provides that an uneven surface topography of the component, which likewise effects changes in radiation intensity, is smoothened or levelled out with a smoothening layer made of a material whose volume-specific radiation absorption corresponds to that of the component material, so that a decrease of radiation absorption or an increase in radiation intensity due to an uneven surface geometry is avoided and density of the radiographic film is only produced by internal material defects. This enables a precise, preferably also automated radiographic inspection to be performed, which is crucial in particular for safety-relevant components.

In a further development of the present invention, the smoothening or levelling layer applied to the component surface is made of a plastically deformable material with metal powder embedded therein.

The maximum metal powder content in the smoothening layer is not higher than required for ensuring adequate deformability of the material in order to produce a smooth, even surface contour.

The smoothening layer is of such a nature that it can be removed or stripped off the component after radiographic inspection.

The method variants according to the present invention enable material defects, such as voids, inclusions, segregations, gas cavities, cracks or bonding defects to be precisely detected both visually and in an automated process.

An embodiment of the present invention is more fully described in light of the accompanying drawing.

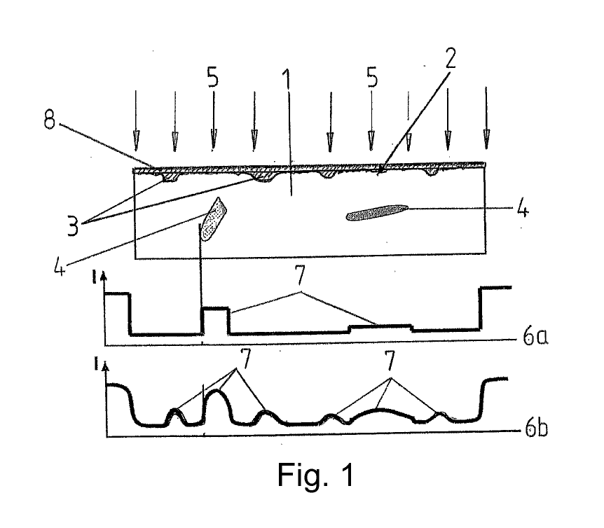

FIG. 1 schematically shows a component suitably prepared according to the present invention during the radiographic inspection.

In the exemplary embodiment, the component 1, which is shown in highly simplified representation, is made of 18.8 chromium nickel steel and has an uneven surface topography 2 with depressions 3. Two voids 4 are present in the interior of the component 1 to be inspected. The component 1 is subjected to X-ray—indicated by arrows 5. These X-rays penetrate the component and produce on the radiographic film 6a or 6b arranged beneath the component a density 7 corresponding to the radiation intensity I.

As shown in the drawing, the uneven surface topography 2 of the component 1 can be covered by a smoothening layer 8 composed of an easily formable material with metal powder embedded therein. The maximum metal powder content—for example 65 percent—is not higher than required for preventing the powder particles from colliding with each other, enabling the material to be well formed and surface irregularities levelled out, i.e. a smooth, even component surface to be produced. The metal powder is made, for example, of the same material as the component, i.e. 18.8 chromium nickel steel, and of other metal powder additions, so that the smoothening layer 8 has the same X-ray absorption as the base material of component 1.

The lower radiographic film 6b schematically shows the intensity of the X-rays and the corresponding densities on the radiographic film 6b upon penetrating the component 1 without the smoothening layer 8 applied. Due to the uneven surface topography 2, radiation intensity I is very high, also in the area of the depressions 3. The radiographic film 6b therefore shows a multitude of not clearly defined densities 7 which do not allow automatic evaluation of the radiographic film 6b and definite—sharp-edged—identification of the densities 7 caused by the voids 4.

The upper radiographic film 6a shows the intensity of the X-rays 5 and the corresponding densities on the radiographic film 6a upon penetrating the component 1 provided with the smoothening layer 8 described above. Owing to the smoothening layer 8, the X-rays 5 are now absorbed also in the area of the uneven surface topography to the same extent as in the base material of component 1. Increased radiation intensity I with more clearly defined density of the radiographic film 6a is noted only at those locations where the X-rays 5 pass the voids 4 in the wall of component 1. The voids 4 are therefore clearly identifiable also with automatic evaluation of the radiographic film 6a, so that increased safety is ensured, for example, when using safety-relevant components for aerospace applications.

After radiographic inspection the smoothening layer 8 can be stripped off the surface of the component.

### List of Reference Numerals

1 Component
2 Uneven surface topography
3 Depressions
4 Voids, material defects
5 X-rays
6a Upper radiographic film
6b Lower radiographic film
7 Density
8 Smoothening layer
I Radiation intensity

What is claimed is:

1. A method for radiographic inspection of a component using at least one of X-rays and gamma rays wherein an absorption and intensity of radiation impinging on a radiographic sensitive device upon passing through the component is changed by material defects in the component, comprising:
applying a smoothening layer over an uneven surface topography of the component, the smoothening layer made of a material having a volume-specific radiation absorption corresponding to that of a base material of the component, thereby reducing an effect of the uneven surface topography on the radiographic sensitive device, in comparison to an effect on the radiographic sensitive device caused by internal material defects of the component, when radiation is passed through the component,
wherein the smoothening layer is made of a plastically deformable material having metal powder embedded therein, the metal powder having a same X-ray absorption as the base material of the component.

2. The method of claim 1, wherein a maximum metal powder content in the smoothening layer is not higher than required for ensuring adequate deformability of the material.

3. The method of claim 2, wherein the smoothening layer is stripped off the component after radiographic inspection.

4. The method of claim 3, wherein the internal material defects, including at least one of voids, inclusions, segregations, gas cavities, cracks and bonding defects, are detected at least one of visually and in an automated process.

5. The method of claim 1, wherein the smoothening layer is stripped off the component after radiographic inspection.

6. The method of claim 5, wherein the internal material defects, including at least one of voids, inclusions, segregations, gas cavities, cracks and bonding defects, are detected at least one of visually and in an automated process.

7. The method of claim 1, wherein the internal material defects, including at least one of voids, inclusions, segregations, gas cavities, cracks and bonding defects, are detected at least one of visually and in an automated process.

8. The method of claim 2, wherein the internal material defects, including at least one of voids, inclusions, segregations, gas cavities, cracks and bonding defects, are detected at least one of visually and in an automated process.

9. The method of claim 1, wherein the application of the smoothening layer substantially eliminates the effect of the uneven surface topography on the radiographic sensitive device, in comparison the effect on the radiographic sensitive device caused by the internal material defects of the component.

10. The method of claim 1, wherein the radiographic sensitive device is radiographic film.

11. The method of claim 1, wherein the effect reduced is a decrease of radiation absorption or an increase in radiation intensity.

12. A method for inspection of a component, comprising:
applying a smoothening layer over an uneven surface topography of the component, the smoothening layer made of a material having a volume-specific radiation absorption corresponding to that of a base material of the component,
the smoothening layer being made of a plastically deformable material having metal powder embedded therein, the metal powder having a same radiation absorption as the base material of the component; and
passing radiation through the smoothening layer applied component and onto a radiographic sensitive device to observe at least one of a decrease of radiation absorption or an increase in radiation intensity caused by defects of the component;
reducing an effect of the uneven surface topography on the radiographic sensitive device with the smoothening layer, in comparison to an effect on the radiographic sensitive device caused by internal material defects, when the radiation is passed through the component, to more clearly identify the internal material defects.

13. The method of claim 12, wherein a maximum metal powder content in the smoothening layer is not higher than required for ensuring adequate deformability of the material.

14. The method of claim 13, wherein the smoothening layer is stripped off the component after radiographic inspection.

15. The method of claim 14, wherein the internal material defects, including at least one of voids, inclusions, segregations, gas cavities, cracks and bonding defects, are detected at least one of visually and in an automated process.

16. The method of claim 12, wherein the smoothening layer is stripped off the component after radiographic inspection.

17. The method of claim 12, wherein the internal material defects, including at least one of voids, inclusions, segregations, gas cavities, cracks and bonding defects, are detected at least one of visually and in an automated process.

18. The method of claim 12, wherein the application of the smoothening layer substantially eliminates the effect of the uneven surface topography on the radiographic sensitive device, in comparison to the effect on the radiographic sensitive device caused by the internal material defects of the component.

19. The method of claim 12, wherein the radiographic sensitive device is radiographic film.

20. The method of claim 12, wherein the effect reduced is a decrease of radiation absorption or an increase in radiation intensity.
